(19) United States
(12) Patent Application Publication
(10) Pub. No.: US 2016/0063326 A1
(43) Pub. Date: Mar. 3, 2016

(54) ILLUMINATION IMAGING DEVICE AND GAZE DETECTING APPARATUS

(71) Applicant: Alps Electric Co., Ltd., Tokyo (JP)

(72) Inventors: Tatsumaro Yamashita, Miyagi-ken (JP); Eiki Matsuo, Nagano-ken (JP)

(21) Appl. No.: 14/798,853

(22) Filed: Jul. 14, 2015

(30) Foreign Application Priority Data
Aug. 29, 2014 (JP) 2014-176152

(51) Int. Cl. G06K 9/00; G02B 27/14; G02B 27/28; G02B 5/30; H04N 5/232; H04N 5/225

(52) U.S. Cl. CPC G06K 9/00604; G06K 9/0061; H04N 5/23219; H04N 5/2256; G02B 27/283; G02B 5/3058; G02B 5/3083; G02B 27/147; G02B 27/141

(57) ABSTRACT

An illumination imaging device includes a combination of a polarizing plate, which is a grid polarizer, and a wave plate is provided at the intersection of an optical axis of a first light source that emits light and an optical axis of an imaging member. The light emitted from the first light source is reflected by the polarizing plate, is transmitted through the wave plate, and is fed to an object. The optical axis of the first light source and the optical axis of the imaging member coincide with each other. Therefore, a clear bright-pupil image is acquired by the imaging member.

### CLAIM OF PRIORITY

This application claims benefit of priority to Japanese Patent Application No. 2014-176152 filed on Aug. 29, 2014, which is hereby incorporated by reference in its entirety.

### BACKGROUND

1. Field of the Disclosure

The present disclosure relates to an illumination imaging device that is capable of emitting illuminating light substantially coaxially with an imaging optical axis of an imaging member, and also relates to a gaze detecting apparatus including the illumination imaging device.

2. Description of the Related Art

Retinas of human eyes are retroreflective. Light that has entered an eye through a pupil is strongly reflected in the direction opposite to the direction of incidence on the eye. A known gaze detecting apparatus detects the gaze of an object by taking an image of the face of the object. Specifically, a light source is positioned coaxially with the optical axis of an imaging camera such that the optical path of the reflection from an eye of the object and the optical axis of the imaging camera coincide with each other. In this state, an image of the eye with the pupil being bright is taken. Then, an image of the pupil is extracted from the image of the eye.

There is a known device configured to take an image in the above method. The device employs an annular illumination method (see International Publication No. 2012/020760, for example) in which an annular light source is provided such that the centroid of the brightness distribution (a virtual optical axis) of the annular light source coincides with the optical axis of a camera.

Considering the characteristics of the eye, to acquire a pupil image, illuminating light needs to reach an area of the retina that is to be shot by the camera. However, it is difficult to acquire a pupil image if the area of the retina that is to be shot is small because the pupil is contracted or if the eye is focused on a point in an area at a distance substantially equal to the distance to the camera.

In the above annular illumination method, in spite of the simple configuration, it is difficult to exactly align the optical axis of the light source and the optical axis of the camera. In such an arrangement, if the pupil is contracted or if the eye is focused on a point near the camera, it is difficult to acquire a pupil image having a satisfactory level of brightness.

### SUMMARY

An illumination imaging device includes a first light source configured to emit light; an imaging member configured to acquire an image of an object to which the light emitted from the first light source is fed, the imaging member being provided such that an optical axis of the imaging member intersects an optical axis of the first light source; a dividing element provided at an intersection of the optical axis of the first light source and the optical axis of the imaging member and configured to reflect a portion of the light from the first light source and to transmit a remaining portion of the light; a divergence-angle-adjusting element provided between the first light source and the dividing element and configured to adjust an angle of divergence of the light on the basis of an angle of view of the imaging member; and an antireflection member provided at a position toward which the portion of the light having been transmitted through the dividing element travels.

According to the first aspect of the present invention, the optical axis of the first light source is made to coincide with or is defined close to the optical axis of the imaging member. Therefore, a clear image of the object to which the light from the first light source is fed is acquired. For example, pupil images (including a bright-pupil image and a dark-pupil image) are assuredly acquired even if the pupil of each eye of a person, i.e., the object, is contracted or the eye of the object is focused on a point in an area at a distance substantially equal to the distance to the imaging member.

According to a second aspect, a gaze detecting apparatus includes the illumination imaging device according to the first aspect of the present invention, and a second light source configured to emit light having a wavelength longer than a wavelength of the light emitted from the first light source. The imaging member acquires a bright-pupil image when the first light source is on, and the imaging member acquires a dark-pupil image when the second light source is on.

### BRIEF DESCRIPTION OF THE DRAWINGS

FIG. 1 is a schematic diagram of an illumination imaging device according to an embodiment of the present invention;

FIG. 2 is a block diagram of a gaze detecting apparatus including the illumination imaging device according to the embodiment of the present invention;

FIGS. 3A and 3B are plan views illustrating the relationship between the direction in which an eye of an object is oriented and the position of the illumination imaging device; and

FIGS. 4A and 4B illustrate how to calculate the direction of the gaze from the center of a pupil and the center of reflection from a cornea.

### DESCRIPTION OF THE EXEMPLARY EMBODIMENTS

An illumination imaging device according to an embodiment of the present invention will now be described in detail with reference to the accompanying drawings. The following description concerns an illumination imaging device intended for a gaze detecting apparatus that detects the gaze of an object.

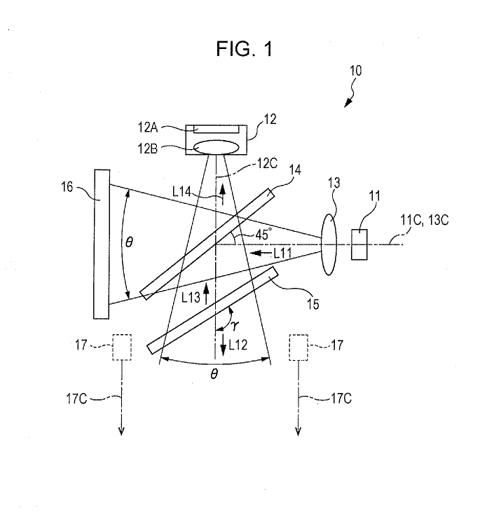

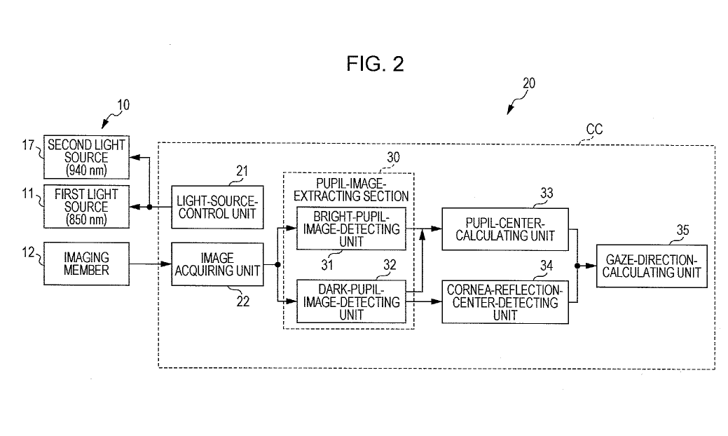

FIG. 1 is a schematic diagram of an illumination imaging device 10 according to the embodiment of the present invention. FIG. 2 is a block diagram of a gaze detecting apparatus 20 including the illumination imaging device 10 according to the embodiment.

As illustrated in FIG. 1, the illumination imaging device 10 according to the embodiment includes a first light source 11, an imaging member 12, a lens 13 functioning as a divergence-angle-adjusting element, a combination of a polarizing plate 14 and a wave plate 15 functioning as a polarization dividing element, and an antireflection member 16.

As illustrated in FIG. 2, the gaze detecting apparatus 20 according to the embodiment includes the illumination imaging device 10 and an arithmetic control unit CC. The gaze detecting apparatus 20 is installed in the interior space of an automobile, for example, on an instrument panel or on an upper part of a windshield, in such a manner as to be oriented toward the face of the driver, i.e., the object.

The first light source 11 illustrated in FIG. 1 is a light-emitting diode (LED) that emits infrared light as detecting light. The lens 13 is provided on the front side of the first light source 11. An optical axis 11C of the first light source 11 and an optical axis 13C of the lens 13 coincide with each other. The detecting light emitted from the first light source 11 travels along an optical path L11 extending along the optical axis 11C and enters the lens 13. The lens 13 is a combination of lenses or an aspherical single lens. The lens 13 has an adjusted light-distributing characteristic and outputs, toward the polarizing plate 14, the detecting light in the form of divergent light having an angle of emergence θ. The angle of emergence θ is determined on the basis of the angle of view of the imaging member 12.

The first light source 11 according to the embodiment is an LED and emits, as detecting light, infrared light (far-red light) having a wavelength of 850 nm (a first wavelength).

The polarizing plate 14 is an optical element that causes little loss of light while reflecting a portion of the incoming light and transmitting the remaining portion of the incoming light on the basis of the kinds of polarized components included in the incoming light. The polarizing plate 14 is preferably, for example, a wire-grid polarizer including a light-transmitting substrate and a number of metal wires (for example, aluminum wires) arranged parallel to one another on the substrate. The wire-grid polarizer transmits incoming light having an electric-field vector perpendicular to the metal wires (the vector is hereinafter defined as a p-polarized component) but reflects incoming light having an electric-field vector parallel to the metal wires (the vector is hereinafter defined as an s-polarized component).

The first light source 11, which is an LED, emits detecting light including the above polarized components. Most of the s-polarized component is reflected by the wire-grid polarizer, whereas most of the p-polarized component is transmitted through the wire-grid polarizer. The light emitted from the first light source 11 is caused to diverge at the angle of emergence θ by the lens 13. The divergent s-polarized component that is incident on the wire-grid polarizer is reflected by the wire-grid polarizer in the form of divergent light.

The polarizing plate 14 is inclined toward an object side at 45 degrees with respect to the optical axis 11C of the first light source 11 and the optical axis 13C of the lens 13. Hence, the reflection from the polarizing plate 14 travels, in the form of divergent light, in a direction at 90 degrees with respect to the optical axis 13C of the lens 13 (i.e., along an optical path L12).

The wave plate 15 is provided in the optical path L12 of the reflection from the polarizing plate 14. The wave plate 15 is inclined at a predetermined angle γ with respect to the optical path L12 of the reflection from the polarizing plate 14. The polarizing plate 14 and the wave plate 15 are not parallel to each other. The wave plate 15 is inclined with respect to an optical axis 12C. Therefore, the light from the first light source 11 is reflected by the wave plate 15, whereby the occurrence of flare that may enter the imaging member 12 is prevented. The angle of inclination γ depends on the angle of view of the imaging member 12. The polarizing plate 14 and the wave plate 15 are not parallel to each other. This is because if the wave plate 15 is at the same angle as the polarizing plate 14, the size of the wave plate 15 increases. If the polarizing plate 14 and the wave plate 15 are bonded to each other as a unit, the wave plate 15 is at the same angle (at 45 degrees in this case) as the polarizing plate 14.

The wave plate 15 may be, for example, a λ/4 wave plate. The phase of the s-polarized component reflected by the polarizing plate 14 is shifted by 90 degrees by being transmitted through the wave plate 15. Thus, the light is circularly polarized. The circularly polarized light obtained as a result of the reflection by the polarizing plate 14 and the transmission through the wave plate 15 travels toward the face of the object. The light in this process is in the form of diffused light and therefore illuminates a wide area including the eyes of the object, or substantially the entirety of the face of the object.

The light reflected by the area including the eyes (substantially the entirety of the face) of the object is fed back toward the wave plate 15 along the optical path L13. In this process, the feedback light has its phase shifted by 180 degrees at the reflection by the object. Thus, the light is circularly polarized in the direction opposite to the direction of circular polarization experienced when traveling along the optical path L12. When this circularly polarized light is transmitted through the wave plate 15, which is a λ/4 wave plate, most of the transmitted light is converted into a p-polarized wave. Most of the p-polarized wave is then transmitted through the polarizing plate 14, and travels toward the imaging member 12 along an optical path L14.

The imaging member 12 includes an imaging device 12A and an objective lens 12B. The imaging device 12A includes, for example, a complementary metal-oxide semiconductor (CMOS) or a charge-coupled device (CCD). The objective lens 12B has an angle of view that is substantially equal to the angle of emergence θ of the lens 13. The objective lens 12B focuses the light reflected by the eyes of the object and transmitted through the polarizing plate 14 upon the imaging device 12A. The imaging member 12 is provided such that the optical axis 12C thereof is substantially orthogonal to the optical axis 11C of the first light source 11. The polarizing plate 14 is provided at the intersection of the optical axis 12C and the optical axis 11C. The optical axis 12C of the imaging member 12 coincides with the optical path L14 of the light traveling from the polarizing plate 14 toward the imaging member 12. The light transmitted through the wave plate 15 and the polarizing plate 14 is received by the imaging member 12 as an image of the face, including the eyes, of the object, i.e., the driver. The imaging device 12A detects the light with a plurality of pixels that are arrayed two-dimensionally.

As illustrated in FIG. 1, the antireflection member 16 is provided across the polarizing plate 14 from the lens 13 and extends over an area defined by the angle of emergence θ of the lens 13. In other words, the antireflection member 16 is provided on an optical path of a portion of the light that has been emitted from the first light source 11 toward the polarizing plate 14 and has been transmitted through the polarizing plate 14. The antireflection member 16 is a reflector that reduces the amount of feedback light by changing the direction of the optical path of the light received, or is made of a material that absorbs the light received. For example, the antireflection member 16 is made of a material that absorbs light having the same wavelength as the light emitted from the first light source 11. The antireflection member 16 has an irregular surface with wedge-like convexities and concavities, thereby having increased absorptance and increased antireflection effect.

The wire-grid polarizer employed as the polarizing plate 14 has a reflectance of about 90% for the s-polarized component and a transmittance of about 80% for the p-polarized component. The proportion of the p-polarized component in the light emitted from the first light source 11 and whose distribution has been adjusted by the lens 13 is about 50%, in general. The transmittance of the wave plate 15 is about 98%. Hence, the rate at which the light emitted from the first light source 11 and traveling along associated optical paths is utilized for the acquisition of an image by the imaging device 12A is calculated as follows, ignoring portions of the light that may be attenuated by associated elements excluding the polarizing plate 14 and the wave plate 15:

0.5 (the proportion of the s-polarized component in the light transmitted through the lens 13)×0.9 (the reflectance of the polarizing plate 14 for the s-polarized component)×0.98 (the transmittance of the wave plate 15)×0.98 (the transmittance of the wave plate 15)×0.8 (the transmittance of the polarizing plate 14 for the p-polarized component)=0.346 (34.6%)

In contrast, in a case where the combination of the polarizing plate 14 and the wave plate 15 is substituted for by a typical metal half mirror, the amount of light that reaches the imaging device 12A from the first light source 11 is about 16% at most because the metal absorbs the light. With the combination of the polarizing plate 14 and the wave plate 15, a clear image of the object is acquired in the case where the light emitted from the first light source 11 is used as illuminating light.

In the embodiment, the imaging member 12 faces the object such as a driver, and the illuminating light emitted from the first light source 11 is reflected by the dividing element and travels toward the object. Alternatively, the first light source 11 may face the object, and the reflection from the object may be reflected by the dividing element before reaching the imaging member 12.

As illustrated in FIG. 1, the gaze detecting apparatus 20 including the illumination imaging device 10 includes second light sources 17.

The second light sources 17 are preferably provided on respective optical paths that are separate from the optical path L11 extending from the first light source 11 to the polarizing plate 14. For example, the second light sources 17 are preferably provided closer to the object than the polarizing plate 14 so as not to be affected by the polarizing plate 14.

The second light sources 17 are each an LED that emits infrared light having a wavelength of 940 nm. The infrared light (far-red light) emitted from the first light source 11 and having a wavelength of 850 nm does not tend to be absorbed in the human eyeball and is reflected at a high rate by the retina at the back of the eyeball. In contrast, the infrared light emitted from each of the second light sources 17 and having a wavelength of 940 nm tends to be absorbed in the human eyeball and is reflected at a low rate by the retina.

The optical path L11 of the light from the first light source 11 is redirected by the polarizing plate 14 and is thus made to substantially coincides with the optical axis 12C of the objective lens 12B included in the imaging member 12. In such a configuration, when the first light source 11 is on, the infrared light at a wavelength of 850 nm is reflected by the retinas of the eyes of the object, passes through the pupils, and is received by the imaging device 12A as a clear image. The image acquired in such a manner is referred to as bright-pupil image. Since the optical axis 11C of the first light source 11 is made to coincide with the optical axis 12C of the objective lens 12B, a clear bright-pupil image is acquired even in a relatively bright environment.

On the other hand, the second light sources 17 are spaced apart from the optical axis 12C of the objective lens 12B. The infrared light emitted from each of the second light sources 17 and having a wavelength of 940 nm is absorbed at a high rate and is reflected at a low rate by the retina. Nevertheless, a small amount of light is reflected by the retina. Since an optical axis 17C of each of the second light sources 17 is spaced apart from the optical axis 12C of the objective lens 12B, the image acquired by the imaging device 12A when the second light sources 17 are on does not tend to include the reflection from the pupil. The image acquired in such a manner is referred to as dark-pupil image.

As illustrated in FIG. 2, the arithmetic control unit CC includes a central processing unit (CPU) and memories included in a computer. The functions of the respective blocks illustrated in FIG. 2 are implemented when the arithmetic control unit CC executes preinstalled software.

The arithmetic control unit CC includes a light-source-control unit 21, an image acquiring unit 22, a pupil-image-extracting section 30, a pupil-center-calculating unit 33, a cornea-reflection-center-detecting unit 34, and a gaze-direction-calculating unit 35.

The image acquiring unit 22 acquires each of frames of the image taken by the imaging member 12. The pupil-image-extracting section 30 reads each of the frames of the image acquired by the image acquiring unit 22. The pupil-image-extracting section 30 includes a bright-pupil-image-detecting unit 31 and a dark-pupil-image-detecting unit 32.

The first light source 11 and the second light sources 17 are each controlled to be turned on and off by the light-source-control unit 21. When the first light source 11 is on, a bright-pupil image is detected by the bright-pupil-image-detecting unit 31 of the pupil-image-extracting section 30. When the second light sources 17 are on, a dark-pupil image is detected by the dark-pupil-image-detecting unit 32.

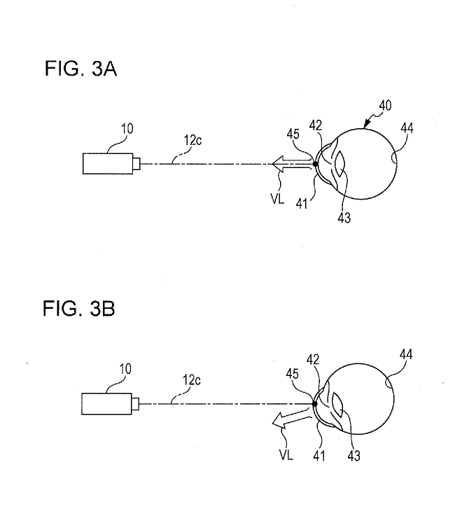

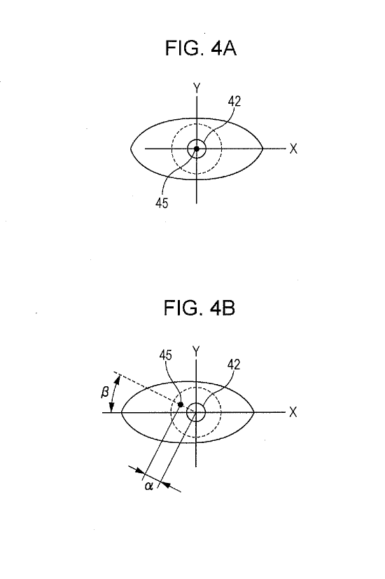

FIGS. 3A and 3B are schematic plan views illustrating the relationship between the direction in which an eye 40 of the object is oriented and the position of the illumination imaging device 10. FIGS. 4A and 4B illustrate how to calculate the direction of the gaze on the basis of the center of the pupil and the center of reflection from the cornea. FIGS. 3A and 4A illustrate a case where a gaze direction VL of the object coincides with the optical axis 12C of the imaging member 12. FIGS. 3B and 4B illustrate a case where the gaze direction VL of the object is shifted from the optical axis 12C of the imaging member 12.

The eye 40 includes a cornea 41 at the front thereof, a pupil 42 and a crystalline lens 43 behind the cornea 41, and a retina 44 at the back thereof.

The light having a wavelength of 850 nm tends to be reflected by the retina 44. Therefore, an image acquired by the imaging member 12 when the first light source 11 is on is composed of infrared light (far-red light) that has been reflected by the retina 44 and has passed through the pupil 42. Consequently, the pupil 42 appears bright in the acquired image, which is extracted as a bright-pupil image by the bright-pupil-image-detecting unit 31. As described above, the optical axis 11C of the first light source 11 is made to substantially coincide with the optical axis 12C of the objective lens 12B included in the imaging member 12. Therefore, when the first light source 11 is on, a clear bright-pupil image is acquired.

On the other hand, the light having a wavelength of 940 nm does not tend to be reflected by the retina 44. Therefore, an image acquired by the imaging member 12 when the second light sources 17 are on is composed of light including little infrared light that has been reflected by the retina 44. Consequently, the pupil 42 appears dark in the acquired image, which is extracted as a dark-pupil image by the dark-pupil-image-detecting unit 32. The optical axis 17C of each of the second light sources 17 is spaced apart from the optical axis 12C of the objective lens 12B. Therefore, the pupil 42 does not tend to appear in the dark-pupil image acquired when the second light sources 17 are on.

In the pupil-image-extracting section 30, the dark-pupil image detected by the dark-pupil-image-detecting unit 32 is subtracted from the bright-pupil image detected by the bright-pupil-image-detecting unit 31, whereby a pupil-image signal representing an image of the pupil 42 that is bright and has a clear shape is generated. The pupil-image signal is supplied to the pupil-center-calculating unit 33. In the pupil-center-calculating unit 33, the pupil-image signal is binarized, and an image of an area representing the shape of the pupil 42 is calculated. Furthermore, an ellipse containing the image of that area is extracted. Then, the intersection of the major axis and the minor axis of the ellipse is determined as the center of the pupil 42.

The light at a wavelength of 850 nm and the light at a wavelength of 940 nm are both reflected by the surface of the cornea 41. The reflection is detected by each of the bright-pupil-image-detecting unit 31 and the dark-pupil-image-detecting unit 32. In the dark-pupil-image-detecting unit 32, since the image representing the pupil 42 is dark, the reflection from a reflecting point 45 on the cornea 41 is detected as a bright spot in the dark-pupil image.

A dark-pupil-image signal representing the dark-pupil image thus detected by the dark-pupil-image-detecting unit 32 is supplied to the cornea-reflection-center-detecting unit 34. The dark-pupil-image signal includes a brightness signal representing the reflection from the reflecting point 45 on the cornea 41 illustrated in FIGS. 3B and 4B. The reflection from the reflecting point 45 on the cornea 41 forms a Purkinje image. As illustrated in FIG. 4B, the image taken by the imaging device 12A of the imaging member 12 is an image of a spot having an extremely small area. The cornea-reflection-center-detecting unit 34 processes the image of the spot and calculates the center of the reflection from the reflecting point 45 on the cornea 41.

A value representing the center of the pupil 42 that has been calculated by the pupil-center-calculating unit 33 and a value representing the center of reflection from the cornea 41 that has been calculated by the cornea-reflection-center-detecting unit 34 are supplied to the gaze-direction-calculating unit 35. The gaze-direction-calculating unit 35 calculates the gaze direction VL from the calculated pupil-center value and the calculated cornea-reflection-center value.

In the case illustrated in FIG. 3A, the gaze direction VL of the eye 40 of the object coincides with the optical axis 12C of the imaging member 12. In this state, as illustrated in FIG. 4A, the center of the reflecting point 45 on the cornea 41 coincides with the center of the pupil 42. In contrast, in the case illustrated in FIG. 3B, the gaze direction VL of the eye 40 of the object is shifted from the optical axis 12C of the imaging member 12. In this state, as illustrated in FIG. 4B, the center of the pupil 42 is shifted from the center of the reflecting point 45 on the cornea 41.

The gaze-direction-calculating unit 35 calculates a direct distance a (see FIG. 4B) between the center of the pupil 42 and the center of the reflecting point 45 on the cornea 41. Furthermore, an X-Y coordinate with the pupil 42 being the origin is defined, and an angle of inclination β formed between the X axis and a line connecting the center of the pupil 42 and the center of the reflecting point 45 is calculated. Then, the gaze direction VL is calculated from the direct distance a and the angle of inclination β.

To accurately calculate the gaze direction VL in the gaze-direction-calculating unit 35, the coordinates at the center of the pupil 42 and the coordinates at the center of the reflecting point 45 need to be detected accurately.

The gaze detecting apparatus 20 preferably includes two illumination imaging devices 10 each including the first light source 11, the second light sources 17, and the imaging member 12. With the two illumination imaging devices 10, the pupil image and the Purkinje image can be obtained three-dimensionally by a stereo method.

The embodiment employing the above configuration produces the following advantageous effects.

(1) The optical path L14 of the light reflected from the eye 40 of the object, transmitted through the polarizing plate 14, and entering the imaging member 12 coincides with the optical axis 12C of the imaging member 12. Therefore, a bright-pupil image is assuredly acquired even in a bright environment or even if the pupil of the eye of the object is contracted or the eye of the object is focused on a point in an area at a distance substantially equal to the distance to the imaging member 12. Hence, the direction of the gaze of the object is detected accurately, regardless of the situation in which an image is taken.

(2) Since the polarizing plate 14 is employed as an optical element, the attenuation of the detecting light emitted from the first light source 11 and the reflection from the eye of the object is reduced. Therefore, the utilization efficiency of the detecting light is maintained at a high level. Hence, a satisfactory amount of light is fed to the imaging member 12. Accordingly, the reduction in the signal-to-noise (SN) ratio is prevented. Consequently, the extraction of the pupil image and the detection of the gaze direction are implemented with high accuracy.

(3) If the polarizing plate 14 is a grid polarizer, high polarization-separation performance is provided in a wide wavelength band from visible light to infrared light. Furthermore, since the polarizing plate 14 has superior heat resistance, polarization separation is implementable even in a high-temperature environment such as the interior space of an automobile. Furthermore, the infrared light that has been diverged by the lens 13 is allowed to be fed to the object.

(4) Since the antireflection member 16 is provided, light that has been transmitted through the polarizing plate 14 and not being fed to the object is prevented from entering the imaging member 12. Hence, the gaze direction of the object is detected accurately.

(5) Since the lens 13 functioning as a divergence-angle-adjusting element is provided, the relationship between the angle of view of the imaging member 12 and the angle of illumination with the illuminating light is optimized. Consequently, the illumination efficiency is increased, and the occurrence of flare is reduced.

Modifications of the present invention will now be described.

(a) Modifications of Apparatus

While FIG. 1 illustrates a case where the second light sources 17 are spaced apart from the optical axis 11C of the first light source 11, two light sources (light-emitting chips) that emit respective rays of light having two different wavelengths may be provided at the position where the first light source 11 is provided. In such a case, the detecting light to be emitted is selectable from infrared light at a wavelength of 850 nm (a first wavelength) and infrared light at a wavelength of 940 nm (a second wavelength).

To avoid the pupil from clearly appearing in the dark-pupil image, the optical axis 17C of each of the second light sources 17 that emit light at 940 nm is preferably spaced apart from the optical axis 12C of the objective lens 12B.

Alternatively, LEDs or the like that each emit light at the same wavelength as the first light source 11 may be employed as the second light sources 17 and may each be provided at a position that is spaced far apart from the optical axis 12C of the objective lens 12B. In such a case, a bright-pupil image is taken by the imaging device 12A when the first light source 11 that emits light whose optical axis 11C is coaxial with the optical axis 12C of the objective lens 12B is on, and a dark-pupil image is taken by the imaging device 12A while the light sources whose optical axes are spaced far apart from the optical axis 12C of the objective lens 12B are on.

(b) Modifications of Dividing Element

In the above embodiment, a combination of the polarizing plate 14 and the wave plate 15 is employed as a polarization dividing element. In the known art, an element such as a polarizing plate made of resin that is stretched in one direction or a metal half mirror is employed as a dividing element, in general. Such a known dividing element causes relatively great loss of light due to absorption. Hence, the dividing element according to the present invention preferably has high efficiency with little loss of light due to absorption or the like. Exemplary high-efficiency dividing elements include an amplitude dividing element and a wavelength-selectable dividing element, as well as the above-described polarization dividing element.

As an exemplary amplitude dividing element, a polka-dot reflector including a transparent substrate and dots of reflecting portions arranged on the substrate may be employed. In such a reflector, unlike a typical metal half mirror, the reflectance of each of the reflecting portions is made as high as possible. The transmission-to-reflection ratio is determined by the proportions of the total area of the dots of reflecting portions and the total area of the transmitting portions, i.e., portions excluding the reflecting portions. Hence, a dividing element that causes little loss of light due to absorption and whose transmission-to-reflection ratio is nearly 50% can be obtained. Such a dividing element is also advantageous in that changes in the characteristics thereof due to changes in the angle thereof are small.

Alternatively, a wavelength-selectable reflector may be employed as a dividing element. The wavelength-selectable reflector is a mirror that reflects light at a predetermined wavelength band and transmits light at the other wavelength bands. Such a dividing element also provides as high efficiency as the polka-dot dividing element.

(c) Modifications of Divergence-Angle-Adjusting Element

In the above embodiment, the lens 13 in the form of a combination of lenses, an aspherical single lens, or the like is employed as a divergence-angle-adjusting element.

The imaging member 12 is configured to acquire an image of an area defined by a predetermined angle of view. Therefore, the light emitted from the first light source 11 needs to illuminate at least the area defined by the angle of view. The first light source 11, which is an LED in the above embodiment, may alternatively be a solid light source that emits laser light or the like. Such light sources have different angles of divergence that are defined by their physical structures. The divergence-angle-adjusting element adjusts the angle of divergence that is specific to each of the light sources to an angle that fits the area to be imaged. Herein, adjustment of the angle of divergence includes various kinds of adjustment performed in accordance with the type of the light source used, specifically, a reduction or increase in the angle of divergence of the light source, an improvement of the uniformity, and so forth.

The role of the adjusting element is to focus the illuminating light on the area defined by a required angle of view, to increase the illumination efficiency, to suppress the occurrence of flare by reducing the proportion of irrelevant light, and consequently to improve the SN ratio of the resulting image. Exemplary divergence-angle-adjusting elements that have such functions include a reflector, a Fresnel lens, and the like, as well as the lens 13.

(d) Modifications of Antireflection Member

The antireflection member 16 may be a reflector provided while being inclined with respect to the direction of travel of the light emitted from the first light source 11 so that the light is not directly fed back to the dividing element, or may be a structure having microscopic wedges and coated with antireflection coating.

As described above, the illumination imaging device according to the present invention is available in illumination and imaging performed by using a gaze detecting apparatus that detects the gaze of an object.

What is claimed is:

1. An illumination imaging device comprising:
a first light source that emits light;
an imaging member that acquires an image of an object to which the light emitted from the first light source is fed, the imaging member configured such that an optical axis of the imaging member intersects an optical axis of the first light source;
a dividing element provided at an intersection of the optical axis of the first light source and the optical axis of the imaging member and configured to reflect a portion of the light from the first light source and to transmit a remaining portion of the light;
a divergence-angle-adjusting element provided between the first light source and the dividing element and configured to adjust an angle of divergence of the light on the basis of an angle of view of the imaging member; and
an antireflection member provided at a position toward which the portion of the light having been transmitted through the dividing element travels.

2. The illumination imaging device according to claim 1,
wherein the dividing element includes a grid polarizer and a wave plate,
wherein the light includes a p-polarized component and an s-polarized component, and
wherein the wave plate is inclined with respect to the optical axis of the imaging member and the optical axis of the first light source.

3. The illumination imaging device according to claim 1, wherein the dividing element is a polka-dot reflector.

4. The illumination imaging device according to claim 1, wherein the dividing element is a wavelength-selectable reflector.

5. A gaze detecting apparatus comprising:
the illumination imaging device according to claim 1; and
a second light source that emits light having a wavelength longer than a wavelength of the light emitted from the first light source,
wherein the imaging member acquires a bright-pupil image when the first light source is on, and the imaging member acquires a dark-pupil image when the second light source is on.

6. The gaze detecting apparatus according to claim 5, wherein the second light source is provided on an optical path separate from an optical path of the light emitted from the first light source to the dividing element.

7. The gaze detecting apparatus according to claim 5, wherein the second light source is provided on an optical path of the light emitted from the first light source to the dividing element.
